(19) United States
(12) Patent Application Publication
(10) Pub. No.: US 2024/0388747 A1
(43) Pub. Date: Nov. 21, 2024

(54) STREAMING SERVICE METHOD AND SYSTEM WITH CUSTOMIZED INFORMATION SAFETY LEVEL

(71) Applicant: DIGICENTRE COMPANY LIMITED, Taipei City (TW)

(72) Inventor: PENG-KWANG CHEN, Taipei City (TW)

(21) Appl. No.: 18/691,664

(22) PCT Filed: Sep. 14, 2021
(86) PCT No.: PCT/CN2021/118114

§ 371 Date: Mar. 13, 2024

(51) Int. Cl. H04N 21/2347; H04N 21/2187

(52) U.S. Cl. CPC H04N 21/2347; H04N 21/2187

(57) ABSTRACT

A streaming service end method and system with customized information safety level, the method contains: a streaming service end receives a video document uploaded by a plurality of application services, splits it into a plurality of packets and performs an encryption operation, and store a decryption key in a key server, send an access token to a plurality of application services, let it obtain a decryption key from a key server and store it in a key relay server to which a plurality of application services belongs. A plurality of application services authenticates logged-in members. If the verification is successful, a decryption key is provided to a plurality of terminal devices. It is worth noting that a plurality of application services does not need to provide any member information to a streaming service. This system can achieve information security and confidentiality.

### CROSS-REFERENCE TO RELATED APPLICATIONS

This is a National Phase Application filed under 35 U.S.C. 371 as a national stage of PCT/CN2021/118114 filed Sep. 14, 2021, the content of which is hereby incorporated by reference in its entirety.

### FIELD OF THE INVENTION

The present invention relates to a streaming service method and system with customized information safety level, and more particularly to a streaming service end that can protect information from disclosure.

### BACKGROUND OF INVENTION

Video streaming service end can be divided into Live stream videoing and Video on Demand. In the past, video streaming application service end providers have to build software and hardware systems by themselves, including application software, streaming software, servers, Internet bandwidth, and colocation. With the development of the Cloud, the above-mentioned problem of colocation is solved by cloud service that uses virtual machines to provide infrastructure as a service.

Because video streaming service end is a cloud application service end, apart from the development of software programs relating to the streaming application, system developers need to develop sophisticated video streaming software. Not only that, developers need to design large-scale software and hardware structures that can provide tremendous services to ensure good user experiences of the mass audience. This can be difficult for most software engineers, and platform as a service for video streaming service end can solve the above problem, allowing application software engineers to focus on their familiar field, and to directly use video streaming service end platforms to provide such services as video streaming software, servers, bandwidth, colocation etc. Application software engineers simply need to use proprietary or standard video player software to display the streamed video on the terminal devices of their application service end software.

As the audience of video streaming service end is a critical asset of the application service end providers, to protect personal information and business secrets, application service end providers will not share any end user information with the platform service provider. Therefore, end users must log into an authentication program to watch the video, and the application service end software system must integrate authentication of login information into the player program, to make sure only authorized users can watch the video. However, using the player program for authorization has a shortcoming, any person that can have access to the streaming URL can avoid using the player provided by the application service end platform, and use any player supporting the video streaming protocol to watch the video without authorization. Therefore, a commonly used method is to encrypt the video and provide a URL of the key API server to the player. The login and authentication information of the application service end is authenticated in the key API server program.

When the streaming service end and application service end are provided by different suppliers, another problem may arise, i.e., the authorization of the terminal application service end. As mentioned above, the audience of the video streaming service end is a critical asset of the application service end providers, and the streaming service end platform does not possess, and cannot access the account data of the terminal application service end. If a third-party login service is used, it may pose a risk that the personal information of the users may be disclosed, or the video may be recorded without authorization. Thus, the security of the streaming service end provider will be questioned.

To overcome the above problem, the present invention developed a streaming service end using key proxy technology. Through the invention, streaming content providers (e.g., application service end providers) can provide keys to their users through a standard telecommunication protocol (e.g., https) as a key API server. This key API server is also called a key relay server. Through the present invention, the key API server of the streaming service end provider and the key relay server of the application service end provider will only share keys by a Server-to-Server method. End user authentication or login behavior are both completed on the online system of the application service end provider. In this way, users no longer need to worry that their personal information or business secrets might be disclosed by the streaming service end provider.

### SUMMARY OF THE INVENTION

In view of this, the present invention provides a streaming service method and system with customized information safety level, which can provide streaming service end based on different requirements of the application service end for information safety, and can satisfy the need of application service ends having a high requirement for information safety not to disclose any personal information or business secrets of their members.

The streaming service method and system with customized information safety level provided by the present invention has the following process steps: 1. The application service end system logs into a key API server URL (URL_{A}) of the streaming service end system. The key to the server is provided by the application service end system, and the URL_{A} is possessed by the application service end system; 2. The streaming service end system provides a key API server URL (URL_{S}) and an exclusive access token for the application service end system. The token is confidential, only known by the application service end system and the streaming service end system, and will not be transmitted on the device of the end user or the Internet; 3. When the player obtains the encrypted video streaming data from the streaming service end system, it also obtains the URL_{A}, and the key is obtained indirectly via the URL_{A} as a relay server; 4. The URL_{A} and the player both belong to the application service end system. The URL_{A} can examine the authorization of the application service end of the end user. A key will be provided if the user is authorized to watch the video streaming, otherwise no key will be provided and the unauthorized user can not watch the streaming contents; 5. The URL_{A} program is provided by the application system. The program provides a key upon request from the player, but it does not have the key. Therefore, it must obtain a key from the URL_{S} in real time using the private token. To ensure the key is only transmitted to the specific application service end system, the URL_{S} program will check if the token is correct.

Preferably, the streaming service method and system with customized information safety level can satisfy the need of an application service end (service provider) for different levels of information safety, for example, the safety of teaching videos of a cram school.

If the cram school only has a general requirement for information safety, the processes are as follow: The cram school uploads a video document to a streaming processor, and the streaming processor cuts the video document into a plurality of packets. the packets are stored in a streaming database corresponding to the application service end. A plurality of terminal devices access the streaming database to obtain the packets through a streaming database URL issued by the application service end. On the terminal devices, a player application program is executed to unpack the packets and play the video document.

If the number of audiences of the video stream displayed on the online teaching system developed by the cram school is different from the number of attending students (some people may have found the streaming URL from the online teaching software and can freely watch the teaching contents by entering the URL into an ordinary player software program). Now, the cram school would have a higher requirement for information safety and changes the safety level to middle class, requiring the system to provide an encrypting function, so that only registered student members of the cram school can watch the stream. Therefore, the cram school provides a member list and membership data to the key API server of the system, so that the key API server can authenticate the member identity. The processes are as follow: The streaming processor receives the video document uploaded by the cram school and cuts the video document into packets. The streaming processor encrypts the packets and stores a decryption key to a key API server. The packets are annotated with a key API URL (URLs) and stored in the streaming database. Through the URL of the streaming database provided by the cram school, the terminal devices obtain the packets, and through the annotated URLs, further access the key API server belonging to the streaming service end. Based on the member list provided by the application service end, the streaming service end conducts verification. If the identity is verified, it provides the key to the terminal device. On the terminal devices, the player application program is executed to use the key to unpack the packets and play the video document.

Later, worrying that the membership data might be divulged, the cram school may change the level of information safety to high class. The processes will be as follow: An administration processor requests an application service end to enter a key relay URL (URL_{A}) of a key relay server. The streaming processor accesses the administration processor and receives a video document uploaded by the application service end. The streaming processor cuts the video document into a plurality of packets. The streaming processor encrypts the packets, and stores the key in the key API server. The streaming processor transmits an access token to the cram school. Using the access token, the cram school obtains the key from the key API server, and stores it in the key relay server. After encryption, the video document is further annotated with the key relay URL (URL_{A}) and is stored in the streaming database. Through the URL of the streaming database provided by the cram school, the terminal devices access the streaming database to obtain the packets. In addition, through the URL_{A}, the terminal devices access the key relay server belonging to the cram school. The cram school authenticates the login information by itself to verify the membership. If the membership is successfully verified, the key is provided to the terminal device. It is to be noted that the cram school does not need to provide any membership data to the streaming service end and thus the information safety is guaranteed. On the terminal devices, the player application program is executed to use the key to unpack the packets and play the video document.

### BRIEF DESCRIPTION OF THE DRAWINGS

FIG. 1 The block diagram of streaming service system with customized information safety level.

FIG. 2 The block diagram of streaming service method with customized information safety level.

FIG. 3 The flow chart of embodiment for promotional video.

FIG. 4 The flow chart of embodiment for live stream video.

FIG. 5 The flow chart of embodiment for teaching video.

FIG. 6 The flow chart of embodiment for a preferred.

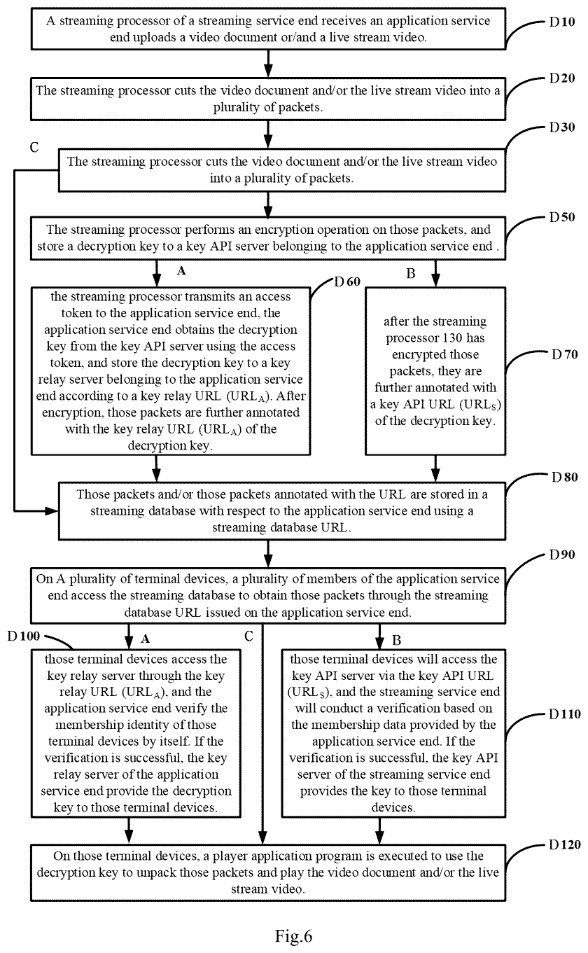

### DETAILED DESCRIPTION OF THE INVENTION

### Embodiment 1

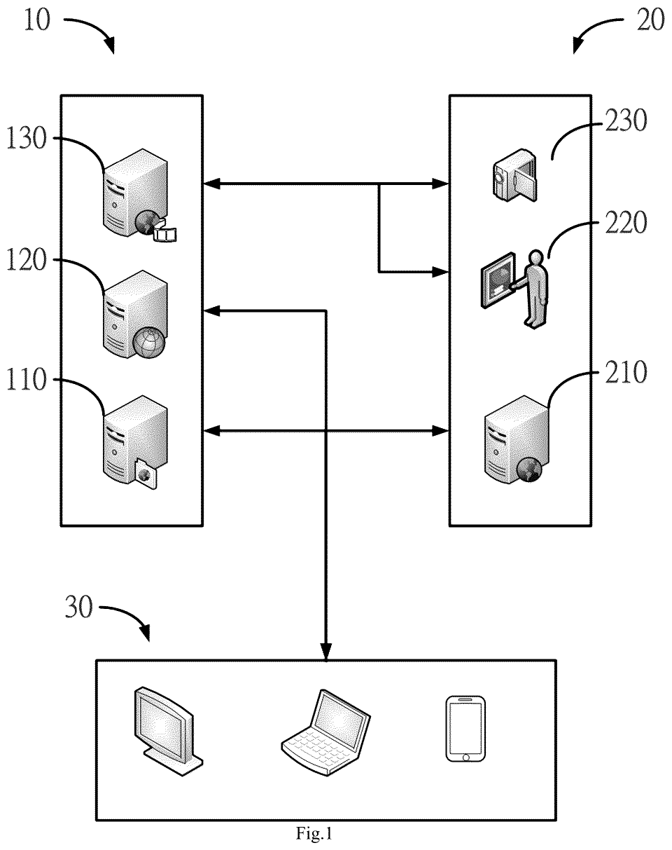

The present invention provides a streaming service method and system with customized information safety level, as shown in [FIG. 1]. The system comprising: a streaming service end 10, to provide streaming service, including an administration processor 120, for an application service end 20 to create an application service end data, the application service end data including a level of information safety, the administration processor 120 being able to check the level of information safety of the application service end 20; a streaming processor 130, to access the administration processor 120, cut a video document 220 and/or a live stream video 230 into a plurality of packets, and conduct an encrypting operation; and to transmit an access token to the application service end 20; a key API server 110 to store a decryption key, and to provide a key API URL (URLs) to the streaming processor for annotation to those packets; the application service end 20 can upload the video document 220 and/or the live stream video 230 to the streaming processor 130 belonging to the streaming service end 10, the application service end 20 including: a key relay server 210, to obtain the decryption key from the key API server 110 of the streaming service end 10 based on the access token, and to provide a relay key URL (URL_{A}) to the streaming processor 130 for annotation to those packets; and a plurality of terminal devices 30 to access the application service end 20, installed with a player application program to unpack those packets and play the video document 220 and/or the live stream video 230 using the decryption key.

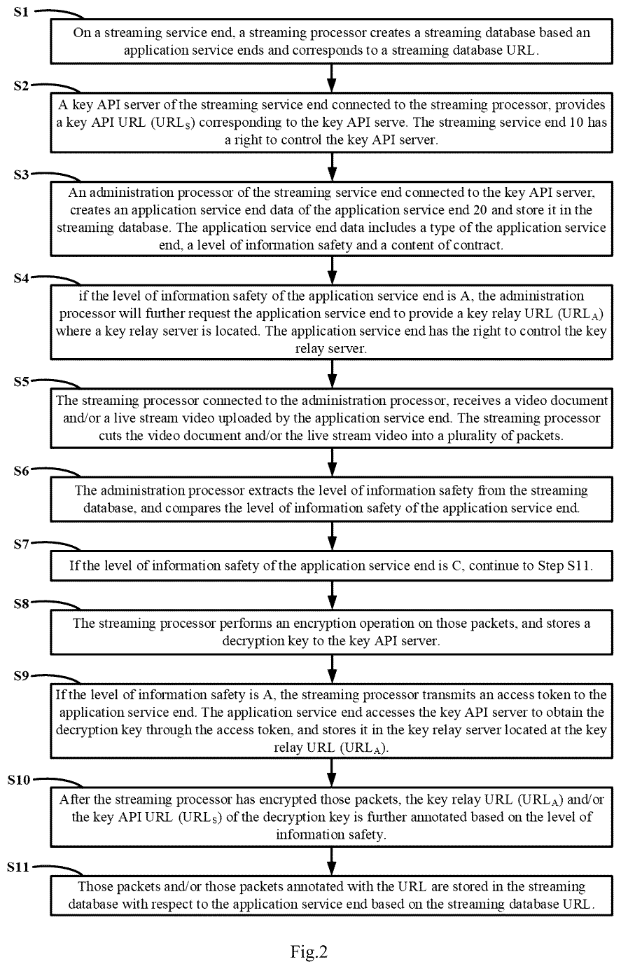

The present invention provides a streaming service method with customized information safety level, as shown in [FIG. 2]. The steps of the method are as follow: S1. On a streaming service end 10, a streaming processor 130 creates a streaming database based an application service ends 20 and corresponds to a streaming database URL. S2. A key API server 110 of the streaming service end 10 connected to the streaming processor 130, provides a key API URL (URLs) corresponding to the key API server 110. The streaming service end 10 has a right to control the key API server 110. S3. An administration processor 120 of the streaming service end 10 connected to the key API server 110, creates an application service end data of the application service end 20 and store it in the streaming database. The application service end data includes a type of the application service end, a level of information safety and a content of contract. The level of information safety includes A (Advanced level), B (Intermediate level), and C (Ordinary level). S4. Specifically, if the level of information safety of the application service end 20 is A, the administration processor 120 will further request the application service end 20 to provide a key relay URL (URL_{A}) where a key relay server 210 is located. The application service end 20 has the right to control the key relay server 210. S5. The streaming processor 130 connected to the administration processor 120, receives a video document 220 and/or a live stream video 230 uploaded by the application service end 20. The streaming processor 130 cuts the video document 220 and/or the live stream video 230 into a plurality of packets. S6. The administration processor 120 extracts the level of information safety from the streaming database, and compares the level of information safety of the application service end 20. S7. If the level of information safety of the application service end 20 is C, continue to Step S11. S8. The streaming processor 130 performs an encryption operation on those packets, and stores a decryption key to the key API server 110. S9. If the level of information safety is A, the streaming processor 130 transmits an access token to the application service end 20. The application service end 20 accesses the key API server 110 to obtain the decryption key through the access token, and stores it in the key relay server 210 located at the key relay URL (URL_{A}). S10. After the streaming processor 130 has encrypted those packets, the key relay URL 210 (URL_{A}) and/or the key API URL 110 (URLs) of the decryption key is further annotated based on the level of information safety. S11. Those packets and/or those packets annotated with the URL are stored in the streaming database with respect to the application service end 20 based on the streaming database URL.

Preferably, in the aforementioned process steps of the present invention, when the level of information safety is A, the key relay server 210 is not set up on the streaming service end 10 of the system, but inside the application program of the application service end 20.

### Embodiment 2: Promotional Video

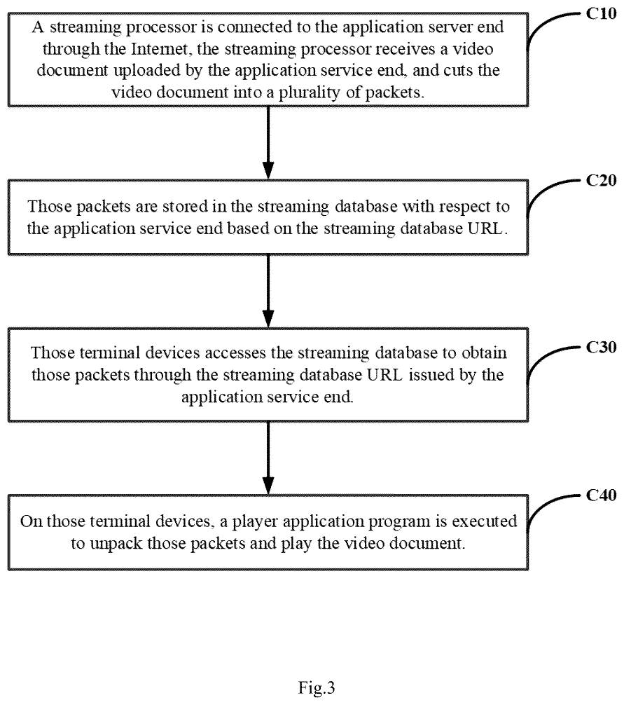

The present invention provides a streaming service method with customized information safety level for an application service end 20 (ex. NPO) to publish a promotional video, as shown in [FIG. 3]. A level of information safety of the application service end 20 is C (Ordinary level), and a streaming database corresponds to a streaming database URL. The process steps of a plurality of terminal devices 30 are as follow: C10. A streaming processor 130 is connected to the application server end 20 through the Internet, the streaming processor 130 receives a video document 220 uploaded by the application service end 20, and cuts the video document 220 into a plurality of packets. C20. Those packets are stored in the streaming database with respect to the application service end 20 based on the streaming database URL. C30. Those terminal devices 30 accesses the streaming database to obtain those packets through the streaming database URL issued by the application service end 20. C40. On those terminal devices 30, a player application program is executed to unpack those packets and play the video document 220.

### Embodiment 3: Live Stream Video

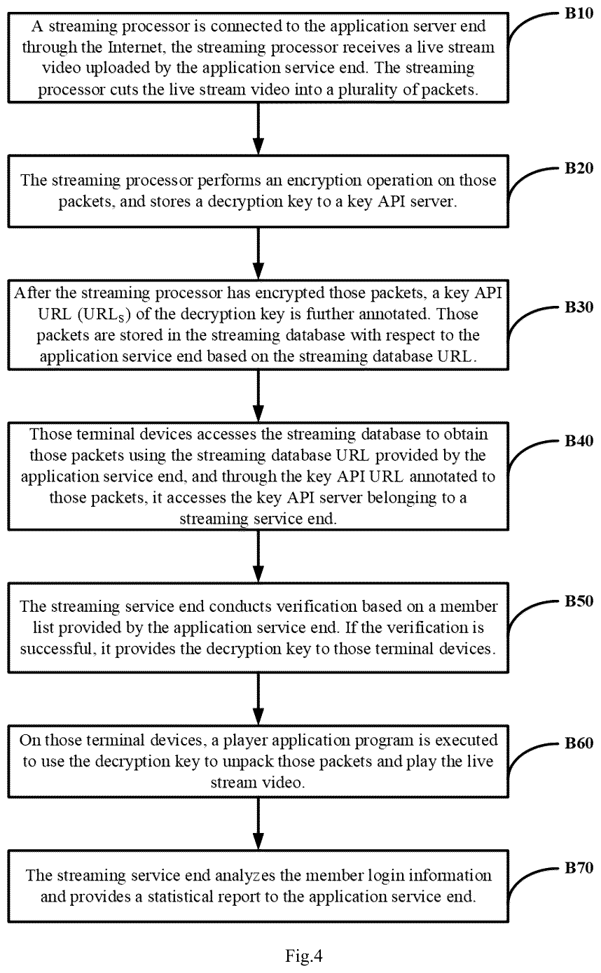

The present invention provides a streaming service method with customized information safety level for a live streamer to publish a live stream video, as shown in [FIG. 4]. A level of information safety of An application service end 20 is B (Intermediate level), and a streaming database corresponds to a streaming database URL. The process steps of a plurality of terminal devices 30 are as follow: B10. A streaming processor 130 is connected to the application server end 20 through the Internet, the streaming processor 130 receives a live stream video 230 uploaded by the application service end 20. The streaming processor 130 cuts the live stream video 230 into a plurality of packets. B20. The streaming processor 130 performs an encryption operation on those packets, and stores a decryption key to a key API server 110. B30. After the streaming processor 130 has encrypted those packets, a key API URL (URLs) of the decryption key is further annotated. Those packets are stored in the streaming database with respect to the application service end 20 based on the streaming database URL. B40. Those terminal devices 30 accesses the streaming database to obtain those packets using the streaming database URL provided by the application service end 20, and through the key API URL annotated to those packets, it accesses the key API server 110 belonging to a streaming service end 10. B50. The streaming service end 10 conducts verification based on a member list provided by the application service end 20. If the verification is successful, it provides the decryption key to those terminal devices 30. B 60. On those terminal devices 30, a player application program is executed to use the decryption key to unpack those packets and play the live stream video 230. B70. The streaming service end 10 analyzes the member login information and provides a statistical report to the application service end 20.

In the above embodiment, Step B50 can also be as follow: After the streaming service end 10 receives the member login information, it submits the login information to the application service end 20 for authentication.

### Embodiment 4: Teaching Video

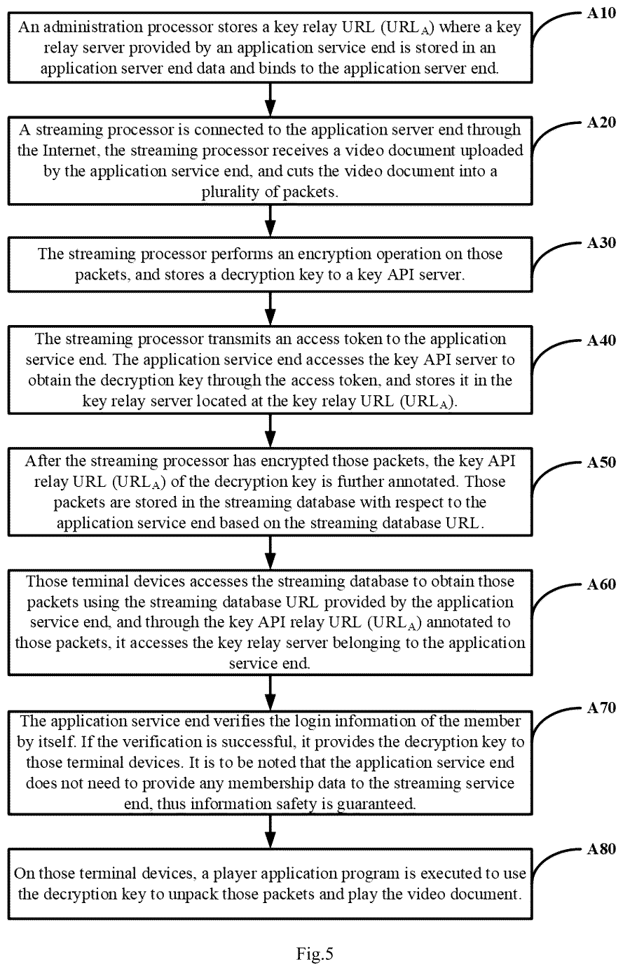

The present invention provides a streaming service method with customized information safety level for a cram school to publish a teaching video, as shown in [FIG. 5]. A level of information safety of an application service end 20 (the cram school) is A (Advanced level), and a streaming database corresponds to a streaming database URL. The process steps of a plurality of terminal devices 30 are as follow: A10. An administration processor 120 stores a key relay URL (URL_{A}) where a key relay server 210 provided by an application service end 20 is stored in an application server end data and binds to the application server end 20. A20. A streaming processor 130 is connected to the application server end 20 through the Internet, the streaming processor 130 receives a video document 220 uploaded by the application service end 20, and cuts the video document 220 into a plurality of packets. A30. The streaming processor 130 performs an encryption operation on those packets, and stores a decryption key to a key API server 110. A40. The streaming processor 130 transmits an access token to the application service end 20. The application service end 20 accesses the key API server 110 to obtain the decryption key through the access token, and stores it in the key relay server 210 located at the key relay URL (URL_{A}). A50. After the streaming processor 130 has encrypted those packets, the key API relay URL (URL_{A}) of the decryption key is further annotated. Those packets are stored in the streaming database with respect to the application service end 20 based on the streaming database URL. A60. Those terminal devices 30 accesses the streaming database to obtain those packets using the streaming database URL provided by the application service end 20, and through the key API relay URL (URL_{A}) annotated to those packets, it accesses the key relay server 210 belonging to the application service end 20. A70. The application service end 20 verifies the login information of the member by itself. If the verification is successful, it provides the decryption key to those terminal devices 30. It is to be noted that the application service end 20 does not need to provide any membership data to the streaming service end 10, thus information safety is guaranteed. A80. On those terminal devices 30, a player application program is executed to use the decryption key to unpack those packets and play the video document 220.

### Embodiment 4: Processes of a preferred embodiment

The present invention provides a streaming service method and system with customized information safety level, the processes of the preferred embodiment are as follow: D10. A streaming processor 130 of a streaming service end 10 receives an application service end 20 uploads a video document 220 or/and a live stream video 230. D20. The streaming processor 130 cuts the video document 220 and/or the live stream video 230 into a plurality of packets. D30. The streaming processor 130 extracts a level of information safety from a streaming database and compare the level of information safety of the application service end 20. D40. If the level of information safety of the application service end 20 is C (Ordinary level), continue to Step D80. D50. The streaming processor 130 performs an encryption operation on those packets, and store a decryption key to a key API server 110 belonging to the application service end 20. D60. If the level of information safety is A (advanced level), the streaming processor 130 transmits an access token to the application service end 20, the application service end 20 obtains the decryption key from the key API server 110 using the access token, and store the decryption key to a key relay server 210 belonging to the application service end 20 according to a key relay URL (URL_{A}). After encryption, those packets are further annotated with the key relay URL (URL_{A}) of the decryption key. D70. If the level of information safety is B (Intermediate level), after the streaming processor 130 has encrypted those packets, they are further annotated with a key API URL (URLs) of the decryption key. D80. Those packets and/or those packets annotated with the URL are stored in a streaming database with respect to the application service end 20 using a streaming database URL. D90. On A plurality of terminal devices 30, a plurality of members of the application service end 20 access the streaming database to obtain those packets through the streaming database URL issued on the application service end 20. D100. If the level of information safety is A, those terminal devices 30 access the key relay server 210 through the key relay URL (URL_{A}), and the application service end 20 verify the membership identity of those terminal devices 30 by itself. If the verification is successful, the key relay server 210 of the application service end 20 provide the decryption key to those terminal devices 30. D110. If the level of information safety is B, those terminal devices 30 will access the key API server 110 via the key API URL (URLs), and the streaming service end 10 will conduct a verification based on the membership data provided by the application service end 20. If the verification is successful, the key API server 110 of the streaming service end 10 provides the key to those terminal devices 30. D120. On those terminal devices 30, a player application program is executed to use the decryption key to unpack those packets and play the video document 220 and/or the live stream video 230.

It is to be noted that an embodiment of the present invention combines the use of “cloud service platforms”. The present invention effectively solves the problem of confidentiality during the transmission of a key. As the key has to be given to the end user through a “to b” client and the identity verification will inevitably involve the providers of platforms, the “to b” client will have the worry that the videos might be recorded by the platform providers. This worry can be eliminated by the present invention.

1. A streaming service method with customized information safety level, the method contains:
E10. a streaming processor of a streaming service end receives an application server of an application service end uploads a video document or/and a live stream video through the Internet;
E20. the streaming processor cuts the video document and/or the live stream video into a plurality of packets;
E30. the streaming processor extracts a level of information safety from a streaming database and compare the level of information safety of the application service end;
E40. the streaming processor performs an encryption operation on those packets, and store a decryption key to a key API server belonging to the application service end;
E50. if the level of information safety is advanced level, the streaming processor transmits an access token to the application service end, the application service end obtains the decryption key from the key API server using the access token, and store the decryption key to a key relay server belonging to the application service end according to a key relay URL (URLA), after encryption, those packets are further annotated with the key relay URL (URLA) of the decryption key;
E60. those packets annotated with the key relay URL (URLA) are stored in the streaming database with respect to the application service end using a streaming database URL;
D70. on a plurality of terminal devices, a plurality of members of the application service end access the streaming database to obtain those packets through the streaming database URL issued on the application service end;
D80. those terminal devices access the key relay server through the key relay URL (URLA), and the application service end verify the members identity of those terminal devices by itself, If the verification is successful, the key relay server of the application service end provide the decryption key to those terminal devices;
D90. on those terminal devices, a player application program is executed to use the decryption key to unpack those packets and play the video document and/or the live stream video.

2. The method defined in claim 1, wherein the key relay server with the information safety level being advanced level is governed by the application service end and has the administrative right.

3. The method defined in claim 1, wherein the level of information safety of the application service end is ordinary level, Step D30 continues with the following steps:
D200. store those packets corresponding to the application service end to the streaming database according to the streaming database URL;
D210. on those terminal devices, those members of the application service end access the streaming database to obtain those packets through the streaming database URL issued on the application service end;
D220. on those terminal devices, the player application program is executed to unpack those packets and play the video document and/or the live stream video.

4. The method defined in claim 1, wherein the level of information safety of the application service end is intermediate level, Step D40 continues with the following steps:
D300. after the streaming processor has encrypted those packets, a key API URL (URLS) of the decryption key is further annotated;
D310. those packets annotated with the key API URL (URLS) are stored in the streaming database with respect to the application service end based on the streaming database URL;
D320. on those terminal devices, those members of the application service end access the streaming database to obtain those packets through the streaming database URL issued on the application service end;
D330. those terminal devices will access the key API server via the key API URL (URLS), and the streaming service end will conduct a verification based on the membership data provided by the application service end, if the verification is successful, the key API server of the streaming service end provides the decryption key to those terminal devices;
D340. on those terminal devices, the player application program is executed to use the decryption key to unpack those packets and play the video document and/or the live stream video.

5. The method defined in claim 4, wherein the streaming service end receives the member login information, it submits the login information to the application service end for authentication.

6. The method defined in claim 3, wherein the streaming service end analyzes the member login information and provides a statistical report to the application service end.

7. A streaming service system with customized information safety level, the system comprising: a streaming service end, to provide streaming service, including an administration processor, for an application service end to create an application service end data, the application service end data including a level of information safety, the administration processor being able to check the level of information safety of the application service end; a streaming processor, to access the administration processor, cut a video document and/or a live stream video into a plurality of packets, and conduct an encrypting operation; and to transmit an access token to the application service end; a key API server to store a decryption key, and to provide a key API URL (URLS) to the streaming processor for annotation to those packets; the application service end can upload the video document and/or the live stream video to the streaming processor belonging to the streaming service end, the application service end including a key relay server, to obtain the decryption key from the key API server of the streaming service end based on the access token, and to provide a relay key URL (URLA) to the streaming processor for annotation to those packets; and a plurality of terminal devices to access the application service end, installed with a player application program to unpack those packets and play the video document and/or the live stream video using the decryption key.

8. The system defined in claim 7, wherein the relay key API server is set up in its own system for the application server end.

9. The system defined in claim 7, wherein the streaming processor has encrypted those packets, according to the level of information safety, if it is advanced level, add the relay key URL (URLA), if it is intermediate level, add the key API URL (URLS), and if it is ordinary level, do not add the URL.

10. The system defined in claim 7, wherein the player application program is executed on the terminal devices, the key relay server is requested to provide the decryption key according to the key relay URL (URLA), and the decryption key is requested to the key API server according to the key API URL (URLS).
